(19) United States
(12) Patent Application Publication
(10) Pub. No.: US 2026/0330507 A1
(43) Pub. Date: Oct. 22, 2026

(54) ADAPTIVE LLM-POWERED CONTEXTUAL BANDITS DRIVEN DYNAMIC TACTICS ENGINE

(71) Applicant: AT&T Intellectual Property I, L.P., Atlanta, GA (US)

(72) Inventors: Jianlei Zhang, Allen, TX (US); Bo Gu, Allen, TX (US)

(73) Assignee: AT&T Intellectual Property I, L.P., Atlanta, GA (US)

(21) Appl. No.: 19/182,721

(22) Filed: Apr. 18, 2025

(51) Int. Cl. G06Q 30/0251; G06Q 30/0201; G06Q 30/0282; G06Q 50/00

(52) U.S. Cl. CPC G06Q 30/0269; G06Q 10/40; G06Q 30/0206; G06Q 30/0282

(57) ABSTRACT

Aspects of the subject disclosure may include, for example, methods and devices for optimizing operational tactics using LLM-enhanced contextual bandit algorithms. Unstructured text data is received, contextual embeddings are generated with an LLM, and operational tactics are evaluated through a bandit algorithm. The system balances exploration and exploitation, continuously refining tactics with real-time feedback. Other embodiments are disclosed.

### FIELD OF THE DISCLOSURE

The subject disclosure relates to evaluating operational tactics in communication networks.

### BACKGROUND

In the rapidly evolving telecommunications industry, companies face significant challenges in maintaining a balance between exploring new opportunities and optimizing existing resources. Traditional methods for evaluating operational tactics in communication networks often rely on static features and structured data, which are insufficient in dynamic environments where factors such as economic conditions, political scenarios, and customer preferences are subject to frequent changes. This inflexibility can lead to suboptimal decision-making, increased operational costs, and missed opportunities for competitive advantage.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system functioning within the communication network of FIG. 1 in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a system that integrates large language models with contextual bandit algorithms to dynamically optimize operational tactics in communication networks by leveraging unstructured data and real-time feedback. Other embodiments are described in the subject disclosure.

Various embodiments described herein relate to an advanced system for optimizing operational tactics in communication networks by integrating large language models (LLMs) with contextual bandit algorithms. This approach addresses challenges faced by telecommunications companies in balancing the exploration of new opportunities with the optimization of existing resources. Traditional methods often rely on static features and structured data, which may be inadequate in dynamic environments where factors such as economic conditions, political scenarios, and customer preferences are constantly changing. Various embodiments described herein leverage the flexibility and adaptability of LLMs to process unstructured text data, enabling more informed and dynamic decision-making.

At the core of these embodiments is the LLM-powered contextual bandit agent, which operates within a multi-agent system. Bandit algorithms are particularly useful in scenarios where decisions must be made sequentially under uncertainty, balancing the trade-off between exploration (trying new actions to discover their effects) and exploitation (choosing actions known to yield high rewards). By integrating LLMs, which are capable of understanding and generating human-like text, the system can process vast amounts of unstructured data to generate contextual embeddings. These embeddings provide a rich representation of the current environment, including economic trends, political climates, and socio-cultural influences, which are then used by the bandit algorithm to make more informed decisions.

The LLM-powered contextual bandit agent is capable of incorporating various environmental contexts into its decision-making process. By analyzing competitors' promotional activities, strategies, and market tactics, the agent can dynamically adjust its actions to maintain a competitive edge. The system is designed to balance exploration of new opportunities with the exploitation of existing strengths, continuously learning from the environment to optimize performance.

A useful feature of these embodiments is their ability to address the cold start problem, a common challenge in machine learning applications. By utilizing LLM-generated prior knowledge, the system can make informed decisions from the onset, even in the absence of extensive historical data. This capability is particularly valuable in rapidly changing environments where new customer behaviors, marketing tactics, and external factors such as news and rumors can impact decision-making. The LLM-powered bandit algorithm can generate new tactics in response to contextual changes, allowing for innovative and dynamic strategies.

Various embodiments described herein also include a mechanism for customizing tactics when unification is not required, ensuring that actions are tailored to specific contexts and requirements. This flexibility enhances the overall effectiveness of the system, enabling it to respond intelligently to a wide range of scenarios. The integration of LLM capabilities into the contextual bandit agent enhances its adaptability and effectiveness, providing robust and contextually aware decision-making.

From a technical perspective, the system is highly scalable, capable of handling large-scale data and complex environments. Its adaptability ensures relevance across various scenarios, while its robust decision-making capabilities lead to more accurate and effective strategies. The system's enhanced semantic understanding and adaptive decision-making are useful factors in its success.

The system comprises several components, including a data ingestion module that collects and processes real-time data from various sources, such as economic indicators, political events, competitor actions, and customer interactions. A decision engine utilizes LLM capabilities to analyze this data, generate insights, and make contextually aware decisions that balance exploration and exploitation. The dueling bandit mechanism optimizes decision-making based on preference feedback from the environment, while a feedback loop continuously learns from outcomes and adjusts strategies accordingly.

The embodiments also include an integration layer that seamlessly integrates with existing telecom infrastructure and operational systems, ensuring smooth implementation. Feature extensions to the solution include predictive analytics for forecasting market trends and customer behaviors, enhanced personalization through deeper customer insights, real-time adaptation mechanisms to respond instantly to market changes and competitor actions, and noise and adversarial robustness to ensure reliable performance in varied conditions.

One or more aspects of the subject disclosure include a device, comprising a processing system including a processor and a memory that stores executable instructions that, when executed by the processing system, facilitate performance of operations. The operations may include receiving unstructured text data from a plurality of sources; processing the unstructured text data using a large language model (LLM) to generate contextual embeddings that represent a current marketing environment for a communication network; inputting the contextual embeddings into a contextual bandit algorithm to evaluate a plurality of operational tactics based on predicted rewards; selecting one operational tactic from the plurality of operational tactics to implement; and implementing the one operational tactic in the communication network.

One or more aspects of the subject disclosure include a non-transitory machine-readable medium, comprising executable instructions that, when executed by a processing system including a processor, facilitate performance of operations. The operations may include receiving unstructured text data from a plurality of sources, wherein the unstructured text data includes customer context data; processing the unstructured text data using a large language model (LLM) to generate contextual embeddings that represent a current marketing environment for a communication network; inputting the contextual embeddings into a contextual bandit algorithm to evaluate a plurality of operational tactics based on predicted rewards; selecting one operational tactic from the plurality of operational tactics to implement; and implementing the one operational tactic in the communication network.

One or more aspects of the subject disclosure include a method, comprising: receiving, by a processing system including a processor, unstructured text data from a plurality of sources, including social media, customer reviews, and industry reports, to gather insights into a current operational environment of a communication network; providing the unstructured text data to a large language model (LLM) to generate contextual embeddings of the current operational environment; inputting, by the processing system, the contextual embeddings into a contextual bandit algorithm to evaluate and prioritize a set of operational tactics based on predicted rewards; selecting, by the processing system, one operational tactic from the set of operational tactics to be implemented in the communication network; and implementing, by the processing system, the one operational tactic in the communication network.

Additional aspects of the subject disclosure may include dynamically balancing exploration of new operational tactics and exploitation of known successful operational tactics by leveraging the contextual embeddings provided by the LLM; continuously updating the contextual bandit algorithm with feedback to refine the selection of operational tactics; generating new operational tactics through the LLM based on changes in the contextual embeddings and integrating these tactics into the contextual bandit algorithm for evaluation and deployment; and implementing the one operational tactic by increasing bandwidth for a particular user in the communication network. The plurality of operational tactics may include personalized content delivery based on individual customer preferences and behaviors identified through contextual embeddings, dynamic pricing adjustments based on competitor pricing strategies and market demand fluctuations, and promotional offer optimization based on predicted customer response and competitor activities.

Further aspects may involve the unstructured text data including social media posts, customer reviews, competitor website data, transcripts of interviews, industry reports, and news articles. The method may further comprise refining the contextual bandit algorithm with real-time feedback from the current operational environment to enhance the selection of the one operational tactic, implementing a feedback loop that incorporates performance metrics analysis to adjust operational strategies in response to operational feedback and environmental changes, and implementing the one operational tactic by increasing bandwidth for a particular user in the communication network. The set of operational tactics may include personalized content delivery based on individual customer preferences and behaviors identified through contextual embeddings.

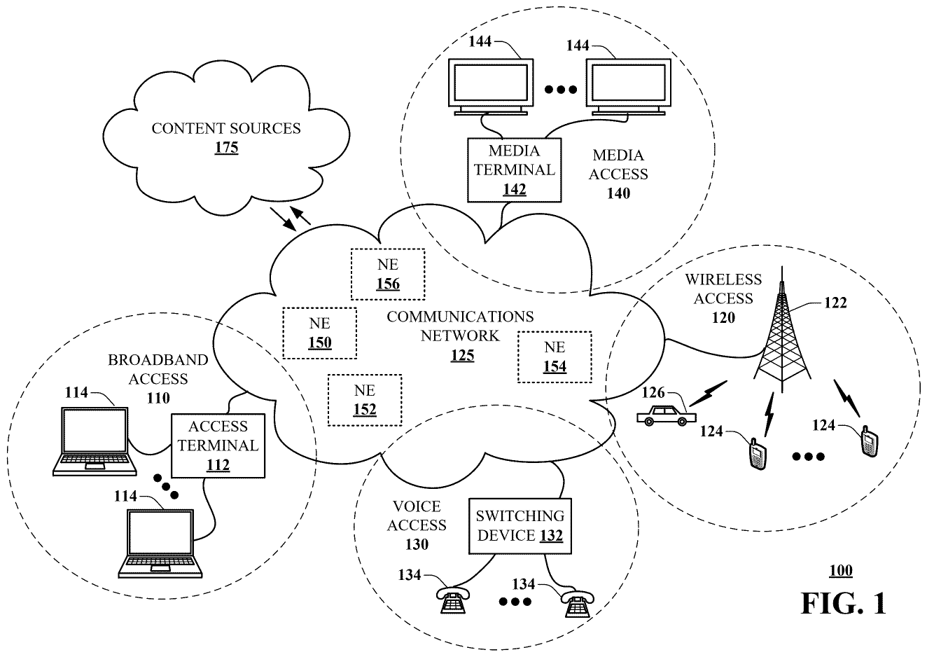

Referring now to FIG. 1, a block diagram is shown illustrating an example, non-limiting embodiment of a system 100 in accordance with various aspects described herein. For example, system 100 can facilitate in whole or in part integrating large language models with contextual bandit algorithms to dynamically optimize operational tactics in communication networks by leveraging unstructured data and real-time feedback. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

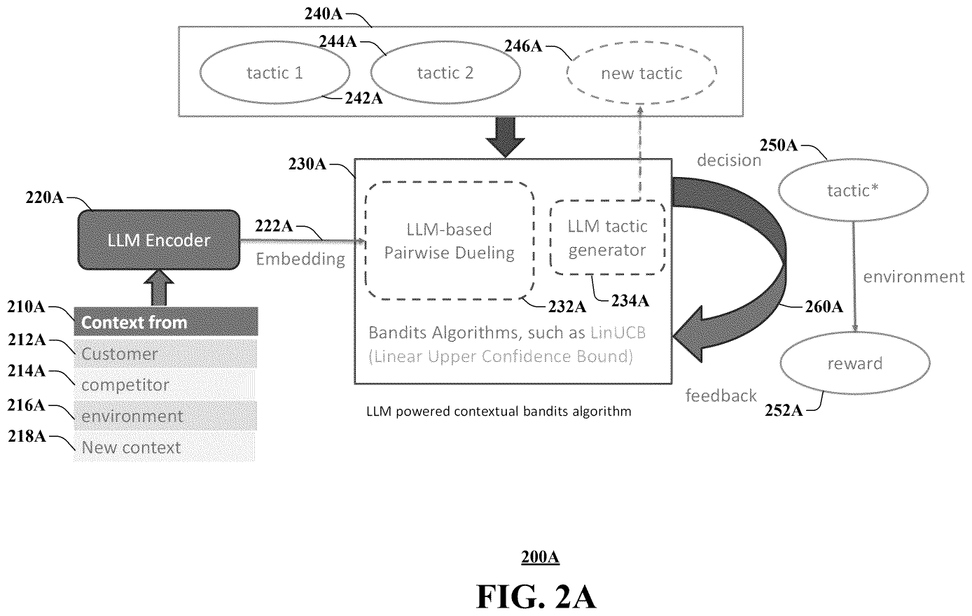

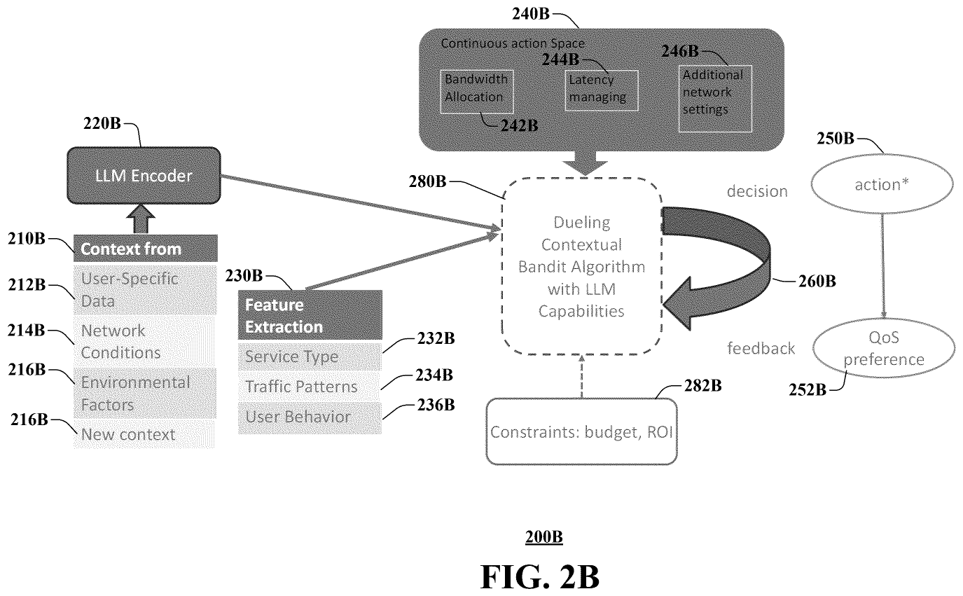

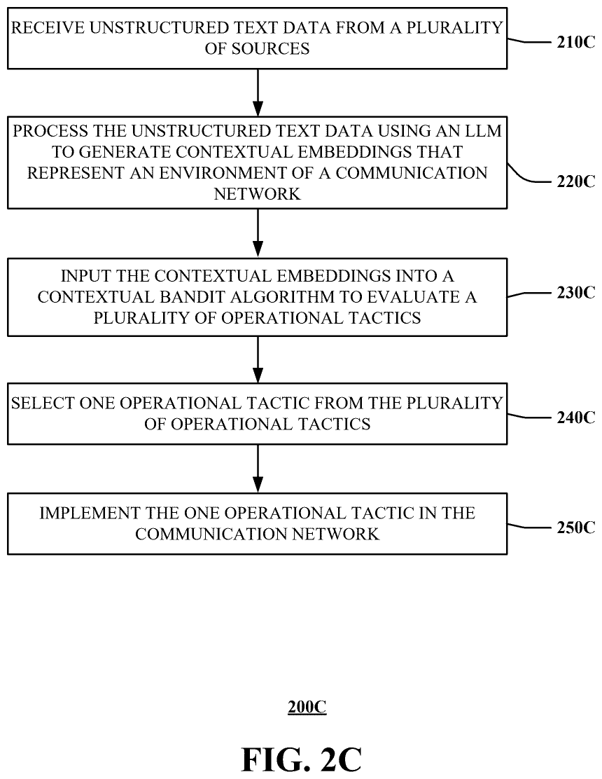

FIG. 2A is a block diagram illustrating an example, non-limiting embodiment of a system functioning within the communication network of FIG. 1 in accordance with various aspects described herein. System 200A integrates a large language model (LLM) with contextual bandit algorithms 230A to optimize operational tactics 240A. The process begins with the collection of context 210A, which includes inputs from various sources such as customer 212A, competitor 214A, environment 216A, and new context 218A. These inputs provide a comprehensive understanding of the current operational environment.

The context 210A is derived from a variety of unstructured text documents collected from multiple sources. For example, customer 212A data may include social media posts, customer reviews, and feedback forms, which provide insights into customer preferences and behaviors. Competitor 214A information might be gathered from competitor websites, press releases, and industry reports, offering a view of market strategies and promotional activities. Environment 216A data could encompass economic indicators, political news articles, and socio-cultural trends, which help in understanding the broader market conditions. New context 218A might involve emerging trends or sudden changes in the market, such as viral news or unexpected events, which require rapid adaptation.

The LLM Encoder 220A plays a role in processing this diverse and unstructured context 210A. It takes in the raw text data and utilizes the capabilities of the LLM to transform it into embeddings 222A. The LLM Encoder 220A leverages advanced natural language processing techniques to parse and understand the semantic content of the text. It identifies key features and patterns within the data, capturing the underlying meaning and relationships between different pieces of information.

The resulting embeddings 222A are large vector representations that encapsulate the rich, multidimensional nature of the input data. Each embedding is a high-dimensional vector that encodes semantic information, allowing the system to capture subtle nuances and complex interdependencies within the context. This vector representation is a strength of the LLM, as it enables the system to handle vast amounts of unstructured data efficiently and effectively, providing a comprehensive and nuanced understanding of the environment.

The embeddings are then fed into the bandit algorithms 230A, which include LLM-based pairwise dueling 232A and an LLM tactic generator 234A. Bandit algorithms are named after the “multi-armed bandit” problem, a classic problem in probability theory and decision-making. The problem is analogous to a gambler facing several slot machines (or “one-armed bandits”) and needing to decide which machines to play, how many times to play each, and in what order, to maximize their total reward. The strength of bandit algorithms lies in their ability to balance exploration (trying new actions to discover their effects) and exploitation (choosing actions known to yield high rewards).

Pairwise dueling 232A is a technique used within the bandit algorithms to compare two potential actions or tactics directly against each other. This method is particularly useful in addressing the cold start problem, which occurs when there is insufficient historical data to make informed decisions. By leveraging pairwise dueling, the system can quickly evaluate new tactics by directly comparing them to existing ones, even when prior knowledge is limited. This approach allows the system to make informed decisions from the onset, accelerating the learning process and reducing the reliance on extensive historical data.

The operational tactics 240A include various strategies that are dynamically generated and adjusted based on the contextual information provided by the embeddings 222A. Examples of operational tactics include increasing bandwidth for a particular user in the communication network, personalized content delivery based on individual customer preferences and behaviors, dynamic pricing adjustments based on competitor pricing strategies and market demand fluctuations, and promotional offer optimization based on predicted customer response and competitor activities. These tactics are designed to result in tangible changes to the communication network, enhancing its performance and responsiveness to real-time conditions.

Tactics 242A and 244A represent established strategies within the operational framework of the communication network. These tactics are derived from historical data and proven methodologies, focusing on optimizing network performance and enhancing user experience. For instance, tactic 242A might involve personalized content delivery, where the system tailors media and information based on individual customer preferences and behaviors identified through contextual embeddings. This approach ensures that users receive content that is most relevant to their interests, thereby increasing engagement and satisfaction. Tactic 244A could involve dynamic pricing adjustments, where the system analyzes competitor pricing strategies and market demand fluctuations to offer competitive pricing models. By adjusting prices in real-time, the network can attract more customers and maximize revenue while maintaining a competitive edge.

New tactic 246A introduces innovative strategies that are generated in response to emerging trends and contextual changes. This tactic leverages the flexibility of the LLM-powered contextual bandit algorithm to explore uncharted territories and develop novel approaches to network optimization. An example of new tactic 246A could be the implementation of adaptive bandwidth allocation, where the system dynamically adjusts data rates for different users and services based on real-time network conditions and user demands. This ensures optimal resource utilization and enhances the quality of service, particularly during peak usage times or major events. Another example might be the deployment of targeted retention offers, where the system identifies users at risk of churn and provides personalized incentives to retain them, such as exclusive discounts or bundled services.

The integration of these tactics into the operational framework is facilitated by the LLM-based pairwise dueling mechanism, which allows for direct comparison and evaluation of potential strategies. By continuously assessing the effectiveness of tactics 242A, 244A, and new tactic 246A, the system can refine its decision-making process and adapt to changing market conditions. This dynamic approach ensures that the communication network remains agile and responsive, capable of delivering high-quality service and maintaining a competitive advantage in the telecommunications industry. The selected operational tactic 250A is then deployed, and the performance of the tactic is monitored through a feedback loop 260A. This feedback loop is crucial in refining the decision-making process, as it provides real-time data on the effectiveness of the implemented tactic. The reward 252A is used to assess the success of the tactic, allowing the system 200A to learn and adapt continuously.

In the context of FIG. 2A, rewards 252A are used to assess the success of the implemented operational tactics 240A and provide feedback to the system 200A for continuous learning and adaptation. Examples of rewards 252A in a communication network setting may include increased network throughput, which can be quantified by measuring the rise in data throughput across the network after implementing a tactic such as increasing bandwidth for specific users. Reduced latency is another potential reward, particularly if an operational tactic aims to optimize routing paths or manage network congestion, resulting in a measurable reduction in latency experienced by users. Improved user satisfaction can also serve as a reward, indicated by feedback from customer satisfaction surveys or a decrease in customer complaints, reflecting the effectiveness of personalized content delivery or dynamic pricing strategies.

Higher utilization rates of network resources, such as increased occupancy rates of available bandwidth or more efficient use of network infrastructure, can be considered a reward. Additionally, cost savings achieved through optimized resource allocation or energy-efficient network operations can be quantified as rewards. Increased revenue generated from successful promotional offers or dynamic pricing adjustments that attract more customers or increase spending is another example of a reward. Enhanced network reliability, demonstrated by fewer dropped connections or reduced downtime, can also be considered a reward. Finally, market share growth as a result of competitive strategies and tactics can be a significant reward, reflecting the system's ability to adapt to market conditions effectively. These rewards provide valuable metrics for evaluating the success of operational tactics and guide the system in refining its strategies to achieve optimal performance in the communication network.

FIG. 2B is a block diagram illustrating an example, non-limiting embodiment of a system functioning within the communication network of FIG. 1 in accordance with various aspects described herein. FIG. 2B shows an embodiment of System 200B, which integrates a Dueling Contextual Bandit Algorithm with LLM Capabilities (DCBAWLC) 280B to optimize network operations. The System 200B comprises several components, including LLM Encoder 220B, Context 210B, Feature Extraction 230B, Continuous action Space (CAS) 240B, Constraints 282B, action 250B, QoS preference 252B, and feedback 260B. These components interact to process data and make informed decisions regarding network management.

The LLM Encoder 220B is responsible for processing the Context 210B, which includes User Specific Data (USD) 212B, Network Conditions 214B, Environmental Factors 216B, and new context. This encoder utilizes advanced natural language processing techniques to transform unstructured data into a format suitable for further analysis.

The LLM Encoder 220B is responsible for processing the Context 210B, which includes User Specific Data (USD) 212B, Network Conditions 214B, Environmental Factors 216B, and new context. This encoder utilizes advanced natural language processing techniques to transform unstructured data into a format suitable for further analysis.

User Specific Data 212B encompasses a variety of information related to individual users, such as their service usage patterns, preferences, and demographic details. Examples include data on the types of services frequently accessed by the user, such as video streaming or online gaming, historical usage patterns indicating peak usage times, and preferences for certain types of content or service features. This data helps tailor network operations to meet individual user needs and enhance their experience.

Network Conditions 214B refer to the current state of the network infrastructure and its performance metrics. Examples include traffic load, which indicates the volume of data being transmitted across the network at any given time; latency, which measures the delay in data transmission; packet loss rates, which reflect the percentage of data packets that fail to reach their destination; and overall network health, which encompasses the reliability and efficiency of network operations. Monitoring these conditions is crucial for optimizing network performance and ensuring high-quality service delivery.

Environmental Factors 216B include external influences that can impact network usage and performance. Examples are economic conditions, such as fluctuations in consumer spending that may affect service demand; political scenarios, such as regulatory changes that could influence network operations; socio-cultural trends, such as shifts in consumer behavior or preferences; and geographical factors, such as the location of users and the availability of network resources in different regions. Understanding these factors allows the system to adapt to broader market conditions and optimize its strategies accordingly.

New context refers to emerging trends or sudden changes in the operational environment that require rapid adaptation. Examples include viral news events that lead to spikes in network traffic, technological advancements that introduce new service requirements, or unexpected disruptions such as natural disasters that affect network infrastructure. By incorporating new context, the system can remain agile and responsive, continuously updating its tactics to address evolving challenges and opportunities.

Feature Extraction 230B processes the contextual data to identify important attributes such as Service Type 232B, Traffic Patterns 234B, and User Behavior 236B. This component extracts relevant features that are necessary for the DCBAWLC 280B to evaluate and prioritize operational tactics.

Service Type 232B refers to the categorization of services accessed by users within the network. Examples include video streaming services, which require high bandwidth and low latency to ensure smooth playback; online gaming, which demands real-time data transmission and minimal latency for optimal user experience; and voice-over-IP (VoIP) services, which necessitate consistent data flow and low jitter to maintain call quality. Identifying the service type is crucial for tailoring network resources to meet specific service requirements and enhance user satisfaction.

Traffic Patterns 234B involve the analysis of data flow across the network, including the volume, direction, and timing of data transmission. Examples include peak traffic times, such as evenings when users are more likely to stream videos or engage in online gaming; directional traffic flow, which may indicate regional preferences for certain services; and burst traffic patterns, which can occur during major events or promotions. Understanding these patterns allows the system to manage congestion effectively, allocate resources efficiently, and maintain high-quality service delivery.

User Behavior 236B encompasses the actions and preferences of users as they interact with the network. Examples include browsing habits, such as frequent visits to specific websites or platforms; engagement levels, such as the duration of time spent on particular services; and responsiveness to promotions, such as the likelihood of users to take advantage of special offers or discounts. By analyzing user behavior, the system can personalize content delivery, optimize pricing strategies, and enhance overall user experience, thereby increasing engagement and loyalty.

By extracting these features, Feature Extraction 230B provides the DCBAWLC 280B with the necessary insights to evaluate and prioritize operational tactics, ensuring that decisions are informed, contextually relevant, and aligned with user needs and network conditions.

The DCBAWLC 280B utilizes the extracted features to assess potential actions within the CAS 240B, which includes Bandwidth Allocation 242B, Latency Management 244B, and Additional Network Settings (ANS) 246B. This algorithm balances exploration and exploitation to select the most effective operational tactics based on predicted rewards.

Bandwidth Allocation 242B involves dynamically adjusting the distribution of network bandwidth among users and services to optimize performance. Examples include increasing bandwidth for high-demand services like video streaming during peak hours or allocating additional bandwidth to users experiencing slow connections. By effectively managing bandwidth allocation, the system can ensure smooth service delivery and enhance user satisfaction, particularly during times of high network load.

Latency Management 244B focuses on minimizing delays in data transmission to improve the quality of service. Examples include optimizing routing paths to reduce travel time for data packets or implementing priority queuing for latency-sensitive applications such as online gaming or VoIP services. Effective latency management ensures that users experience minimal delays, leading to improved service quality and user experience.

Additional Network Settings 246B encompass various parameters that can be adjusted to optimize network operations. Examples include error correction levels, which can be tuned to balance data integrity and transmission speed, and routing priorities, which can be adjusted to favor certain types of traffic based on current network conditions. By fine-tuning these settings, the system can adapt to changing demands and maintain optimal network performance.

Constraints 282B, such as budget and ROI, are considered by the Dueling Contextual Bandit Algorithm with LLM Capabilities 280B to ensure that selected actions align with organizational goals and limitations. These constraints guide the decision-making process, ensuring that the system operates within predefined parameters. For instance, budget constraints may limit the extent to which bandwidth can be increased or latency reduced, necessitating a careful balance between cost and performance. Similarly, ROI considerations may impact the prioritization of certain network settings, favoring adjustments that offer the greatest return on investment. By incorporating these constraints, the system can make informed decisions that optimize network operations while adhering to financial and strategic objectives.

The selected action 250B is implemented in the network, with performance monitored through feedback 260B. This feedback loop refines the decision-making process, as the loop provides real-time data on the effectiveness of the implemented action. QoS preference 252B is also considered to ensure that the selected actions meet quality standards and user expectations.

Examples of selected action 250B might include increasing bandwidth allocation for users experiencing slow connections during peak hours, implementing priority queuing for latency-sensitive applications such as online gaming or VoIP services, or adjusting error correction levels to balance data integrity and transmission speed. These actions are chosen based on the predicted rewards from the DCBAWLC 280B, ensuring that they align with the current network conditions and user needs.

The feedback loop 260B provides real-time performance data and user feedback, which can influence the selection of actions within the CAS 240B. For instance, if the feedback indicates that users are experiencing high latency during video streaming, the system might prioritize latency management actions to optimize routing paths and reduce delays. Similarly, if the feedback reveals that certain users are frequently experiencing slow connections, the system might adjust bandwidth allocation to ensure these users receive adequate resources.

By continuously monitoring the effectiveness of implemented actions, the feedback loop allows the system to adapt and refine its strategies, ensuring that the selected actions remain relevant and effective in meeting user expectations and maintaining high-quality service delivery. This dynamic approach enables the system to respond to changing network conditions and user behaviors, optimizing operations and enhancing overall network performance.

FIG. 2C depicts an illustrative embodiment of a method in accordance with various aspects described herein. FIG. 2C illustrates a method 200C that may be performed by components from previous figures, such as the LLM Encoder and the contextual bandit algorithms. The method 200C begins at block 210C, which handles the reception of unstructured text data from multiple sources. This component plays a significant role as it collects diverse data inputs that serve as the foundation for further processing. The unstructured text data may encompass information from social media, customer reviews, industry reports, competitor websites, and news articles. This data offers a broad perspective on the present operational environment of a communication network, capturing dynamic and multifaceted contexts that are useful for informed decision-making.

At block 220C, the method processes the unstructured text data using a large language model (LLM) to generate contextual embeddings that represent an environment of a communication network. The LLM is adept at handling unstructured data, transforming the data into meaningful embeddings that encapsulate the semantic content of the input. These embeddings serve as a rich representation of the current marketing environment, capturing nuances such as economic trends, political climates, and socio-cultural influences. The LLM's ability to generate these embeddings plays a significant role in providing a detailed and adaptable understanding of the environment, which is then used to inform tactical decisions.

Once the contextual embeddings are generated, component 230C inputs these embeddings into a contextual bandit algorithm to evaluate a plurality of operational tactics. The contextual bandit algorithm is designed to handle decision-making under uncertainty, balancing exploration of new tactics with exploitation of known successful ones. By leveraging the contextual embeddings, the algorithm can evaluate operational tactics based on predicted rewards, allowing for a dynamic and informed selection process. This evaluation plays an important role in ensuring that the chosen tactics are not only contextually relevant but also optimized for potential success.

At block 240C, the method selects one operational tactic from the plurality of operational tactics evaluated by the contextual bandit algorithm. This selection process is informed by the predicted rewards associated with each tactic, as determined by the algorithm.

The chosen tactic is expected to offer significant potential benefit based on the current contextual embeddings, ensuring that the decision is both strategic and data-driven. This component plays an important role in translating the insights gained from the embeddings and algorithmic evaluation into actionable strategies.

Finally, at block 250C, the method implements the one operational tactic in the communication network. This implementation involves executing the selected tactic within the network, thereby operationalizing the decision made in the previous step. The implementation process plays a significant role as it translates the theoretical benefits of the tactic into practical outcomes, impacting the network's performance and responsiveness. This component ensures that the communication network adapts to the current environment, leveraging the selected tactic to optimize operations and achieve desired objectives.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

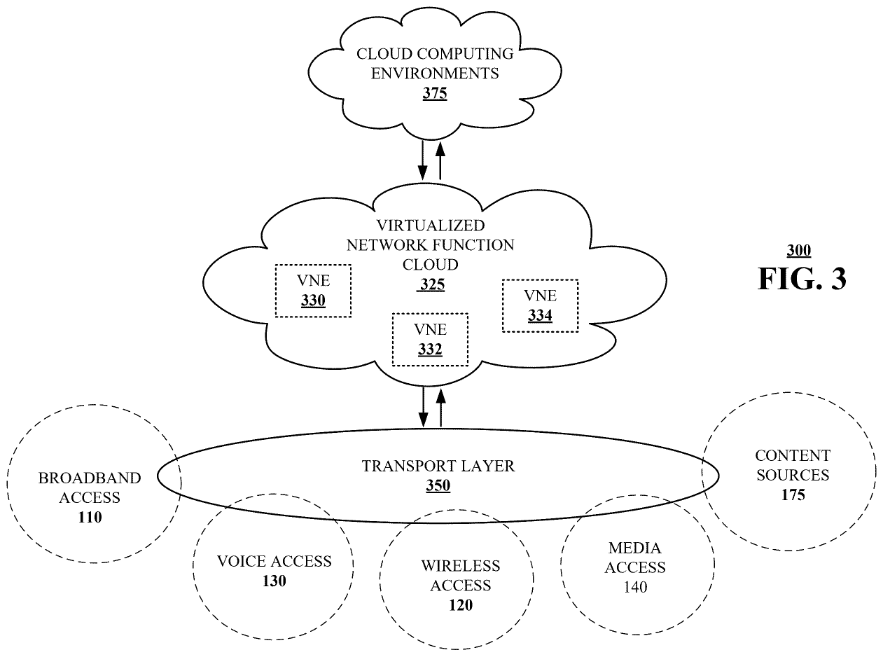

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, and functions described herein. For example, virtualized communication network 300 can facilitate in whole or in part integrating large language models with contextual bandit algorithms to dynamically optimize operational tactics in communication networks by leveraging unstructured data and real-time feedback.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

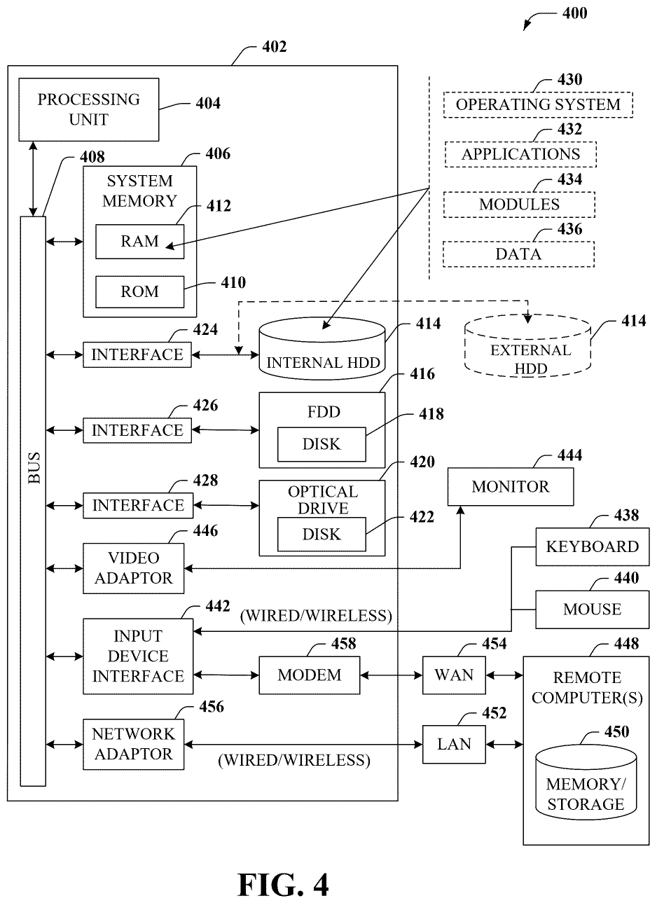

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part integrating large language models with contextual bandit algorithms to dynamically optimize operational tactics in communication networks by leveraging unstructured data and real-time feedback.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

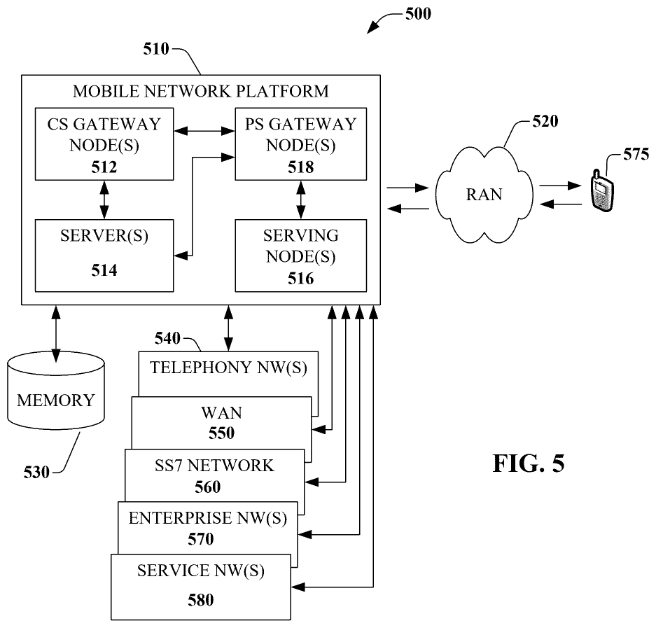

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part integrating large language models with contextual bandit algorithms to dynamically optimize operational tactics in communication networks by leveraging unstructured data and real-time feedback. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

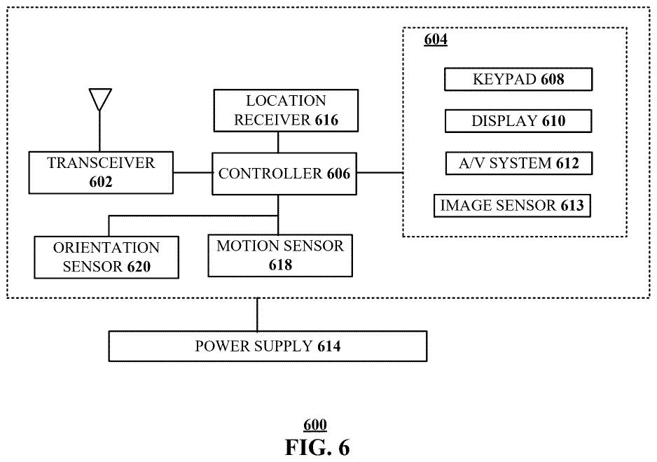

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part integrating large language models with contextual bandit algorithms to dynamically optimize operational tactics in communication networks by leveraging unstructured data and real-time feedback.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

4. The device of claim 1, wherein the operations further comprise generating new operational tactics through the LLM based on changes in the contextual embeddings and integrating these tactics into the contextual bandit algorithm for evaluation and deployment.

5. The device of claim 1, wherein the implementing the one operational tactic comprises increasing bandwidth for a particular user in the communication network.

6. The device of claim 1, wherein the plurality of operational tactics include personalized content delivery based on individual customer preferences and behaviors identified through contextual embeddings.

7. The device of claim 1, wherein the plurality of operational tactics include dynamic pricing adjustments based on competitor pricing strategies and market demand fluctuations.

8. The device of claim 1, wherein the plurality of operational tactics include promotional offer optimization based on predicted customer response and competitor activities.

9. A non-transitory machine-readable medium, comprising executable instructions that, when executed by a processing system including a processor, facilitate performance of operations, the operations comprising:
receiving unstructured text data from a plurality of sources, wherein the unstructured text data includes customer context data;
processing the unstructured text data using a large language model (LLM) to generate contextual embeddings that represent a current operational environment for a communication network;
inputting the contextual embeddings into a contextual bandit algorithm to evaluate a plurality of operational tactics based on predicted rewards, wherein the predicted rewards are indicative of a latency, a resource allocation, or a reliability of the communication network;
selecting, based on the predicted rewards, one operational tactic from the plurality operational tactics to implement; and
implementing the one operational tactic in the communication network by modifying, at a network element or virtualized network element, a network operating parameter, resulting in an improvement of the latency, the resource allocation, or the reliability of the communication network.

10. The non-transitory machine-readable medium of claim 9, wherein the unstructured text data includes social media posts.

11. The non-transitory machine-readable medium of claim 9, wherein the unstructured text data includes customer reviews.

12. The non-transitory machine-readable medium of claim 9, wherein the unstructured text data includes competitor website data.

13. The non-transitory machine-readable medium of claim 9, wherein the unstructured text data includes transcripts of interviews.

14. The non-transitory machine-readable medium of claim 9, wherein the unstructured text data includes industry reports.

15. The non-transitory machine-readable medium of claim 9, wherein the unstructured text data includes news articles.

16. A method, comprising:
receiving, by a processing system including a processor, unstructured text data from a plurality of sources, including social media, customer reviews, and industry reports, to gather insights into a current operational environment of a communication network;
providing the unstructured text data to a large language model (LLM) to generate contextual embeddings that represent the current operational environment;
inputting, by the processing system, the contextual embeddings into a contextual bandit algorithm to evaluate and prioritize a set of operational tactics based on predicted rewards, wherein the predicted rewards are indicative of a latency, a resource allocation, or a reliability of the communication network;
selecting, by the processing system, one operational tactic from the set of operational tactics to be implemented in the communication network; and
implementing, by the processing system, the one operational tactic in the communication network by modifying, at a network element or virtualized network element, a network operating parameter, resulting in an improvement of the latency, the resource allocation, or the reliability of the communication network.

17. The method of claim 16, further comprising refining, by the processing system, the contextual bandit algorithm with real-time feedback from the current operational environment to enhance the selecting of the one operational tactic.

18. The method of claim 16, further comprising implementing, by the processing system, a feedback loop that incorporates performance metrics analysis to adjust operational strategies in response to operational feedback and environmental changes.

19. The method of claim 16, wherein the implementing the one operational tactic comprises increasing bandwidth for a particular user in the communication network.

20. The method of claim 16, wherein the set of operational tactics include personalized content delivery based on individual customer preferences and behaviors identified through contextual embeddings.
